(19) United States
(12) Patent Application Publication
(10) Pub. No.: US 2008/0289947 A1
(43) Pub. Date: Nov. 27, 2008

(54) Vacuum still

(75) Inventor: Hermann Thumm, Lyndoch (AU)

Correspondence Address: THE NATH LAW GROUP;Attorneys at Law, 112 South West Street, Alexandria, VA, 22314, US

(73) Assignee: BARROSA GRAPE PRODUCTS PTY LTD, Lyndoch (AU)

(21) Appl. No.: 12/007,632

(22) Filed: Jan. 14, 2008

(30) Foreign Application Priority Data
May 25, 2007 (AU) 2007902821

(51) Int. Cl. B01D 3/42

(52) U.S. Cl. 202/160

(57) ABSTRACT

A vacuum still for the distillation of grape products has a boiler to heat grape products to a temperature at which nutriments have no or minimal damage, the vapors from the vapor space of the boiler passing through three condensers in series. A vacuum is applied through the condensers in series to the vapor space of the boiler, the concentrated grape product in the boiler being processed into a food product containing the nutriments and vitamins contained in the grape product.

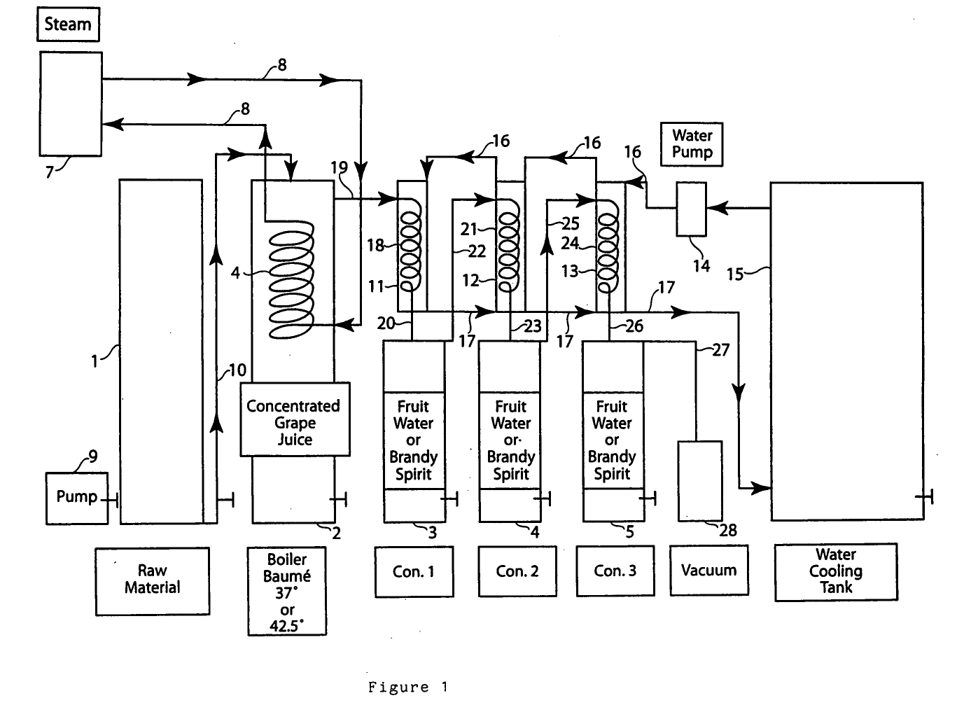

### FIELD OF THE INVENTION

This invention relates to a still for processing grape products under vacuum.

### DESCRIPTION OF THE PRIOR ART

During the past few years large areas of plantings of vines have occurred and it is the belief of the inventor and many others grape juice production far in excess of the grape juice required for wine production will result in a large surplus of grape juice. This will result in lower prices not only for the wines but the return to the individual growers will be substantially reduced. This known to be happening at the present time, there is no market for the grape juice and large areas of vines will be left with the grapes rotting on the vine.

Grape juice is a natural food product being high in sugars such as fructose and glucose. In addition grape juice contains a large number of nutriments and vitamins and includes elements such as potassium, calcium, sodium, phosphorus, magnesium, iron, chlorine as well as a number of elements in minor quantities.

In addition it is known to produce food products from grape juice, such as de-alcoholized white wine, grape nectar from concentrated grape juice having a consistency similar to honey, grape syrup having a consistency similar to Maple Syrup, and grape syrup with a chocolate flavouring used as a topping for ice cream.

However it is very desirable in processing grape juice for food products that the nutriments in the grape juice are not destroyed or harmed in any way.

### OBJECT OF THE INVENTION

Thus it is an object of this invention to provide a still for processing grape products in a manner to maintain or substantially maintain all the nutriments in good condition.

Other objects and advantages of the present invention will become apparent from the following description, taking in connection with the accompanying drawings, wherein, by way of illustration and example, an embodiment of the present invention is disclosed.

### SUMMARY OF THE INVENTION

According to the present invention, although this should not be seen as limiting the invention in any way, there is provided a still for processing a grape product, Comprising a boiler for containing the grape product to be heated, a heater for heating the grape product in the boiler to temperature below which possible damage may occur to the nutriments in the grape product, and vacuum means to apply a reduced pressure in the boiler through a condenser system to remove the volatiles from the grape product.

Preferably the grape product is heated to a temperature in the range of 122° F. (50° C.) to 156° F. (70° C.).

Preferably the pressure in the boiler is reduced close to zero atmospheric pressure.

Preferably the condenser system comprise a plurality of condensers connected in series, preferably three condensers.

Preferably the grape product is grape juice or de-acidified white wine.

### BRIEF DESCRIPTION OF THE DRAWING

By way of example, an employment of the invention is described more fully hereinafter with reference to the accompanying drawing, in which the invention is illustrated by a block diagram showing the elements of the invention.

### DETAILED DESCRIPTION OF THE INVENTION

The vacuum still has a storage vessel 1, a boiler 2, first condenser 3, second condenser 4 and third condenser 5. The boiler 2 includes a heating coil 6 fed by steam or hot water from a heater 7 through line 8, the boiler being supplied with the grape product by pump 9 though line 10.

Each condenser 3, 4 and 5 has a respective water cooling jacket 11, 12 and 13. pump 14 supplies cooling water from cooling tank 15 through water supply line 16 to flow through each cooling jacket in series, from jacket 13 through jacket 12 and return from jacket 11 through line 17 back to the tank 15.

Cooling jacket 11 of condenser 3 has the inlet of cooling coil 18 connected to the vapor space of the boiler 2 by vapor line 19, the outlet of cooling coil 18 opening into the condenser 3.

Cooling jacket 12 of condenser 4 has the inlet of the cooling coil 21 connected to the vapor space of condenser 3, the outlet of the cooling coil 21 opening into condenser 4.

Similarly cooling jacket 13 of condenser 5 has the inlet of cooling coil 24 connected by line 25 to the vapor space of condenser 4, the outlet of cooling coil 24 connected by line 26 to condenser 5, a vacuum pump 28 is connected by line 27 to the vapor space of condenser 4.

Thus it can be seen that the vacuum pump 28 through line 27 provides a reduced pressure through each of the condensers 3, 4 and 5 and respective cooling coil 24, 21 and 18 to the vapor space of boiler 2. As the cooling water flows through the cooling jackets in series from jacket 13 through jacket 12 to cooling jacket 11, cooling jacket 11 will be warmer than cooling jacket 12 which is warmer than cooling jacket 13. Thus during operation the vapors are further cooled as they pass through the coils of the respective condensers thus ensuring the greatest amount of condensate is removed from the vapors.

The vacuum still can be used for various liquids. If wine, such as de-acidified wine is the raw material, alcohol and water are the products produced, the water is excellent drinking water full of vitamins and nutriments, and the alcohol can be used for brandy or fortifying other wines. Alternatively the alcohol can be used as a fuel to produce power.

Grape juice, preferably de-acidified grape juice can be the grape product, whereby in the boiler the grape juice is concentrate, the vapors being condensed in the condensers to produce fruit water. The concentrated grape juice is the processed into a food product with a Baume of 37° to 43°.

As shown taps are provided at the bottom of the boiler and the condensers to permit the removal of the resultant products.

While the vacuum still is primarily directed to the processing of grape products to produce products with vitamins and nutriments by operating at a temperature which preserves the quality of the nutriments, it can also be used for operation at higher temperatures. However it is preferred the vacuum still be used for processing a grape product in a temperature range of 122° F. (50° C.) to 156° F. (70° C.), more particularly at a temperature of 143.6° F. (62° C.).

While the drawing indicates steam is used for heating the boiler, it is to be realized other forms of heating can be used such as hot water, solar heated water, electrical elements and gas heating. Also it is to be noted whereas the condenser system is described as three condensers in series, it is to be noted the invention also includes the use of two condensers in series, however it is realized not all the volatiles may not be removed.

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

The claims defining the invention are as follows:

1. A still for processing a grape product, comprising a boiler for containing the grape product to be heated, a heater for heating the grape product in the boiler to temperature below which possible damage may occur to the nutriments in the grape product, and vacuum means to apply a reduced pressure in the boiler through a condenser system to remove the volatiles from the grape product.

2. A still for processing a grape product as defined in claim 1 wherein the condenser system comprises a plurality of condensers in series.

3. A still for process a grape product as defined in claim 1 wherein the condenser system comprise three condensers in series.

4. A still for processing a grape product as defined in claim 1 wherein the condenser system comprise three condensers in series, wherein each condenser includes a cooling coil in a water jacket, the cooling coils being connected in series with a first cooling coil of a first condenser having its inlet connected to the vapor space of the boiler and its outlet opening into the first condenser, a second cooling coil of the second condenser having its inlet connected to the vapor space of the first condenser and its outlet connected to the second condenser, and said third cooling coil having its inlet connected to the vapor space of the second condenser and its outlet connected to the third condenser, a vacuum applied to the vapor space of the third condenser whereby a reduced pressure is applied through each of the condensers and cooling coils to the vapor space of the boiler.

5. A still for processing a grape product as defined in claim 4 wherein a cooling fluid from its source is connected to flow through each of the water jackets in series, the cooling fluid being supplied to flow through the water jacket of the third cooling coil, flow through the water jacket of the second cooling coil and flow through the water jacket of the first cooling coil and thence flow to the source of cooling fluid.

6. A still for processing a grape product as defined in claim 5 wherein the source of the cooling fluid is a water tank, the water being pumped by a pump through the water jackets.

7. A still for processing a grape product as defined in claim 1 wherein the boiler heats the grape product to a temperature in the range of 122° F. (50° C.) to 156° F. (70° C.)

8. A still for processing a grape product as defined in claim 7 wherein the grape product is heated to 143.6° F. (62° C.).

9. A still for processing a grape product as defined in claim 4 wherein the pressure in the boiler is in the vicinity of zero atmospheric pressure.

10. A still for processing a grape product as defined in claim 3 wherein each of the condensers has a cooling coil connected in series, a first cooling coil having is inlet connected to the vapor space of the boiler, a second cooling coil connected the outlet of the first cooling coil and a third cooling coil connected to the outlet of the second cooling coil, the outlet of the third cooling coil being connected to a source of vacuum, and means for passing a cooling fluid over the cooling coils in sequence from the third cooling coil to the first cooling coil whereby the vapors from the boiler are progressively subjected to further cooling.

11. A still for processing a grape product comprising a boiler to contain the grape product, heating means to heat the grape product to a temperature at which minimal harm will occur to the nutriments in the grape product, a plurality of condensers connected in series to condense the vapors from the boiler, vacuum means to supply a reduced pressure through the series of condensers to the vapor space of the boiler, and cooling means for the condensers whereby the vapor is progressively cooled as the vapor passes through the series of condensers.
